(19) United States
(12) Patent Application Publication
(10) Pub. No.: US 2009/0025464 A1
(43) Pub. Date: Jan. 29, 2009

(54) Surface-roughness/contour measuring apparatus

(76) Inventor: Masafumi Ishii, Ibaraki (JP)

Correspondence Address: CHRISTIE, PARKER & HALE, LLP, PO BOX 7068, PASADENA, CA, 91109-7068, US

(21) Appl. No.: 11/660,132

(22) PCT Filed: May 29, 2006
(86) PCT No.: PCT/JP06/11150

§ 371 Date: Feb. 12, 2007

(30) Foreign Application Priority Data
Aug. 23, 2005 (JP) 2005-240821

(51) Int. Cl. G01B 5/28

(52) U.S. Cl. 73/105

(57) ABSTRACT

A surface-roughness/contour measuring apparatus (1) comprises: a stylus orientation changing part (9) by which a rotatable support part (62, 64, 71a, 71b) for supporting a cantilever (7) in such a manner as to be rotatable on a rotational axis extending in a direction perpendicular to the longitudinal direction of the cantilever (7) is rotated about the longitudinal direction of the cantilever (7), thereby changing the orientation of a stylus (11) provided at a forward end of the cantilever (7); and a balancing member (63) which balances the weight of the cantilever (7) about the rotational axis in order to eliminate the effect of the gravitational force acting on the cantilever (7) rotating with the rotation of the rotatable support part (62, 64, 71a, 71b).

### CROSS-REFERENCE TO RELATED APPLICATION

This application is a National Phase Patent Application of International Application Number PCT/JP2006/311150, filed on May 29, 2006, which claims priority of Japanese Patent Application Number 2005-240821, filed on Aug. 23, 2005.

### TECHNICAL FIELD

The present invention relates to a surface-roughness/contour measuring apparatus and, more particularly, to a surface-roughness/contour measuring apparatus for measuring the surface roughness or contour of a measurement object (workpiece) by moving a stylus along the surface of the measurement object and by detecting the amount of displacement of the stylus.

### DESCRIPTION OF THE RELATED ART

A surface-roughness/contour measuring apparatus measures the surface roughness or contour of a measurement object (workpiece) by moving a pickup equipped with a stylus along the surface of the measurement object (workpiece) and by converting the amount of displacement of the stylus into an electrical signal and reading it into a computer or the like for processing. One such surface-roughness/contour measuring apparatus is disclosed, for example, in Japanese Unexamined Patent Publication No. 2002-107144. FIG. 1 shows the basic configuration of a surface-roughness/contour measuring apparatus according to the prior art.

The surface-roughness/contour measuring apparatus 1 includes a table 2 in an X-Y plane for placing a workpiece thereon, and a column 3 is installed vertically on the table 2. The column 3 is provided with a movable unit 4. A motor not shown is built into the column 3, and the movable unit 4 can be moved up and down the column 3 (i.e., in the Z direction) using the motor. A holder 5 on which a pickup 6 is supported via an arm 10 is attached to the movable unit 4. The movable unit 4 also has a built-in motor not shown, and can drive the holder 5 in the X direction.

The probe (pickup) 6 for measuring the surface roughness of the workpiece placed on the table 2 is attached to the forward end of the arm 10, and the pickup 6 is fitted with a cantilever 7 having a stylus 11 at one end thereof. The cantilever 7 is attached to the pickup 6 by aligning its longitudinal direction parallel to the X direction which is the driving direction of the movable unit 4, and the pickup 6 supports the other end of the cantilever 7, i.e., the end opposite from the stylus 11, in such a manner that the cantilever 7 can be turned on an axis extending in a direction (Y direction) perpendicular to both the longitudinal direction of the cantilever 7 and the projecting direction (Z direction) of the stylus 11.

Accordingly, when the pickup 6 is moved in the X direction by the driving unit 4 while holding the stylus 11 in contact with the measurement surface, the stylus 11 produces fine movements in the Z direction in accordance with the amount of roughness of the measurement surface. The amount of displacement occurring at this time is converted by the cantilever 7 into a rotating motion, which is transmitted to a differential inductance or differential transducer (not shown) built into the pickup 6 and is converted into an electrical signal. This electrical signal is converted into a digital signal by an A/D converter (not shown).

Then, the stylus 11 is moved across the entire area of the measurement surface, and signals sequentially output from the A/D converter are collected by a data processing unit (not shown) such as a computer, thereby acquiring measurement data indicating the surface roughness of the workpiece.

### DISCLOSURE OF THE INVENTION

In the prior art surface-roughness/contour measuring apparatus 1, the projecting direction of the stylus 11 (or the direction of the rotational axis about which the cantilever 7 moves with the fine movement of the stylus 11) is fixed to one particular direction (usually, the projecting direction of the stylus 11 is fixed to the vertically downward direction (the Z-axis direction), and the rotational axis on which the cantilever 7 turns is set parallel to the Y-axis direction).

The reason is that, in the surface-roughness/contour measurement, the measuring force (the force by which the stylus 11 is pressed onto the measurement surface) is defined by various standards (for example, JIS standard B0651), and that it is preferable to fix the projecting direction of the stylus 11 from the standpoint of maintaining the measuring force constant irrespective of the force of gravity.

However, when measuring surface roughness or contour on various surfaces of a workpiece by the prior art surface-roughness/contour measuring apparatus 1 in which the projecting direction of the stylus 11 is fixed, the orientation of the workpiece placed on the table 2 has to be changed in order to bring the stylus 11 into contact with each designated measurement surface. This takes for very laborious work, especially when the workpiece is bulky and heavy.

Furthermore, when measuring, for example, the shape of an interior surface of a cylinder 101 in a cylinder block 100 of an engine such as shown in FIG. 2A, the following problem occurs.

FIG. 2B is an enlarged cross-sectional view of an open end of the cylinder 101 shown in FIG. 2A. In the example shown in FIG. 2B, tapered portions (102 and 103) are formed on the open end of the cylinder 101.

Of these tapered portions, when measuring the surface roughness or contour of the portion 102 whose surface faces upward, the entire workpiece 100 should be tilted, for example, as shown in FIG. 3, by the taper angle θ about the Y axis in the figure, thereby leveling the surface of the tapered portion 102 so that the stylus 11 can be moved along that surface.

On the other hand, when measuring the surface roughness or contour of the tapered portion 103 whose surface faces downward, the entire workpiece 100 must first be rotated 180 degrees about the X axis in the figure so that the surface of the tapered portion 103 faces upward.

Here, in the surface-roughness/contour measurement, the position of the workpiece 100 placed on the table 2 must be known in advance. In particular, when there is a need to rotate the workpiece 100 for measurement as shown above, the position and direction of the rotational axis about which the workpiece 100 is rotated must be known in advance. If the actual rotational axis were displaced from the assumed rotational axis, measurement errors would result because of displacements in the position and direction of the measurement surface.

However, in the case of a rectangular workpiece such as the cylinder block 100 shown in FIG. 2A, the rotational axis of a rotating tool for rotating the workpiece 100 is difficult to set so as to match the assumed rotational angle, because, unlike the case of a cylindrical workpiece or the like, there is no reference on which to set the rotational axis. As a result, with the prior art surface-roughness/contour measuring apparatus 1 in which the direction of the stylus 11 is fixed, it is an extremely laborious procedure to measure the surface roughness or contour on various portions of a rectangular workpiece such as that shown in FIG. 2A.

In view of the above problem, it is an object of the present invention to provide a surface-roughness/contour measuring apparatus in which the orientation of the stylus is changed so as to match the orientation of each designated measurement surface, thereby enabling variously oriented measurement surfaces to be measured without changing the mounting orientation of the workpiece.

To achieve the above object, in the surface-roughness/contour measuring apparatus according to the present invention, a rotatable support shaft member for supporting a cantilever in such a manner as to be rotatable on a rotational axis extending in a direction perpendicular to the longitudinal direction of the cantilever is rotated about the longitudinal direction of the cantilever, thereby changing the orientation of the stylus provided at a forward end of the cantilever.

The apparatus further includes a balancing member which balances the weight of the cantilever by turning about the rotational axis of the cantilever in order to eliminate the effect of the gravitational force acting on the cantilever rotating with the rotation of the rotatable support part.

Then, the rotatable support part is rotated to orient the stylus in a direction that causes the tip of the stylus to contact the measurement surface and, in this condition, the stylus is moved along the measurement surface to measure its surface shape.

The above and other objects and features of the present invention will become clearer from the following description of the preferred embodiment given with reference to the accompanying drawings.

### BRIEF DESCRIPTION OF THE DRAWINGS

FIG. 1 is a diagram the basic configuration of a surface-roughness/contour measuring apparatus according to the prior art.

FIG. 2A is a diagram showing a cylinder block as an example of a workpiece to be measured by the surface-roughness/contour measuring apparatus.

FIG. 2B is an enlarged cross-sectional view of an open end of a cylinder 101 shown in FIG. 2A.

FIG. 3 is a diagram for explaining a measuring method using the prior art surface-roughness/contour measuring apparatus.

FIG. 4 is a diagram showing the basic configuration of a surface-roughness/contour measuring apparatus according to an embodiment of the present invention.

FIG. 5A is an X-Z cross-sectional view of a pickup shown in FIG. 4.

FIG. 5B is a cross-sectional view taken along A-A′ in FIG. 5A.

FIG. 5C is a perspective view of a fixed part shown in FIG. 5A.

FIG. 6A is a perspective view of a pickup rotating unit shown in FIG. 4.

FIG. 6B is an X-Z cross-sectional view of the pickup rotating unit shown in FIG. 6A.

FIG. 7A is a diagram showing how a measurement surface 110 is measured in accordance with a measuring method using the surface-roughness/contour measuring apparatus of FIG. 4.

FIG. 7B is a diagram showing how a measurement surface 111 is measured in accordance with the measuring method using the surface-roughness/contour measuring apparatus of FIG. 4.

FIG. 7C is a diagram showing how a measurement surface 112 is measured in accordance with the measuring method using the surface-roughness/contour measuring apparatus of FIG. 4.

FIG. 7D is a diagram showing how a measurement surface 113 is measured in accordance with the measuring method using the surface-roughness/contour measuring apparatus of FIG. 4.

FIG. 8A is a diagram showing how a tapered portion 102 is measured in accordance with the measuring method using the surface-roughness/contour measuring apparatus of FIG. 4.

FIG. 8B is a diagram showing how a tapered portion 103 is measured in accordance with the measuring method using the surface-roughness/contour measuring apparatus of FIG. 4.

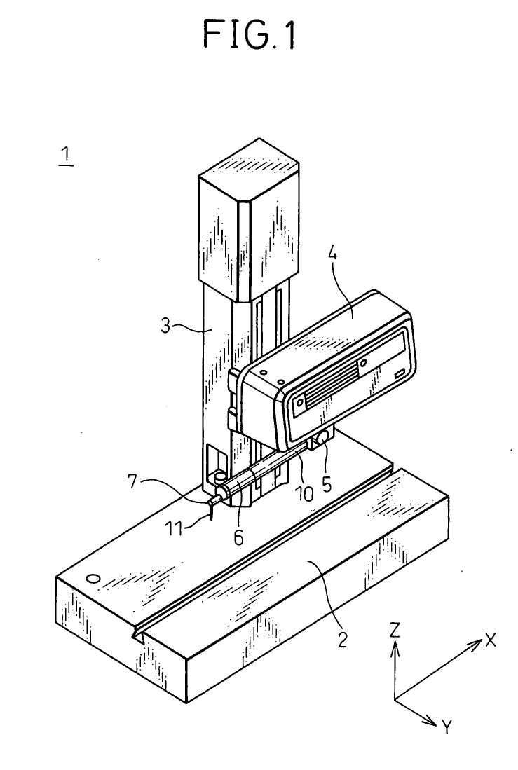

### BEST MODE FOR CARRYING OUT THE INVENTION

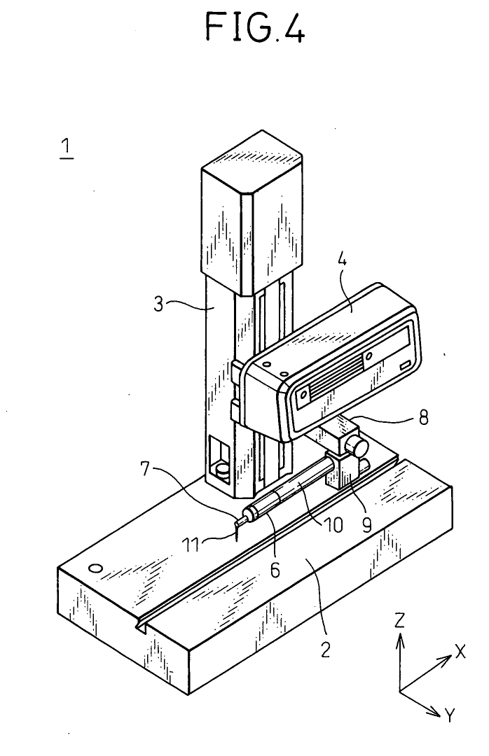

An embodiment of the present invention will be described with reference to the accompanying drawings. FIG. 4 is a diagram showing the basic configuration of a surface-roughness/contour measuring apparatus according to the embodiment of the present invention.

As shown, the surface-roughness/contour measuring apparatus 1 includes a table 2 in an X-Y plane for placing a workpiece thereon, and a column 3 is installed vertically on the table 2. The column 3 is provided with a first movable unit 4. A motor not shown is built into the column 3, and the first movable unit 4 can be moved up and down the column 3 (i.e., in the Z direction) using the motor.

The first movable unit 4 is provided with a second movable unit 8. The first movable unit 4 also has a built-in motor not shown, and can drive the second movable unit 8 in the X direction. A pickup rotating unit 9 on which a pickup 6 is supported via an arm 10 is attached to the second movable unit 8. The second movable unit 8 also has a built-in motor not shown, and can drive the pickup rotating unit 9 in the Y direction.

The probe (pickup) 6 is attached to the forward end of the arm 10, and the pickup 6 is fitted with a cantilever 7 having a stylus 11 at one end thereof. The cantilever 7 is attached to the pickup 6 by aligning its longitudinal direction parallel to the X direction which is the driving direction of the movable unit 4. The stylus 11 is provided at the one end of the cantilever 7 so as to project in a direction substantially perpendicular to the longitudinal direction of the cantilever.

The pickup 6 supports the other end of the cantilever 7, i.e., the end opposite to the stylus 11, in such a manner that the cantilever 7 can be turned on an axis extending in a direction perpendicular to both the longitudinal direction of the cantilever 7 and the projecting direction of the stylus 11.

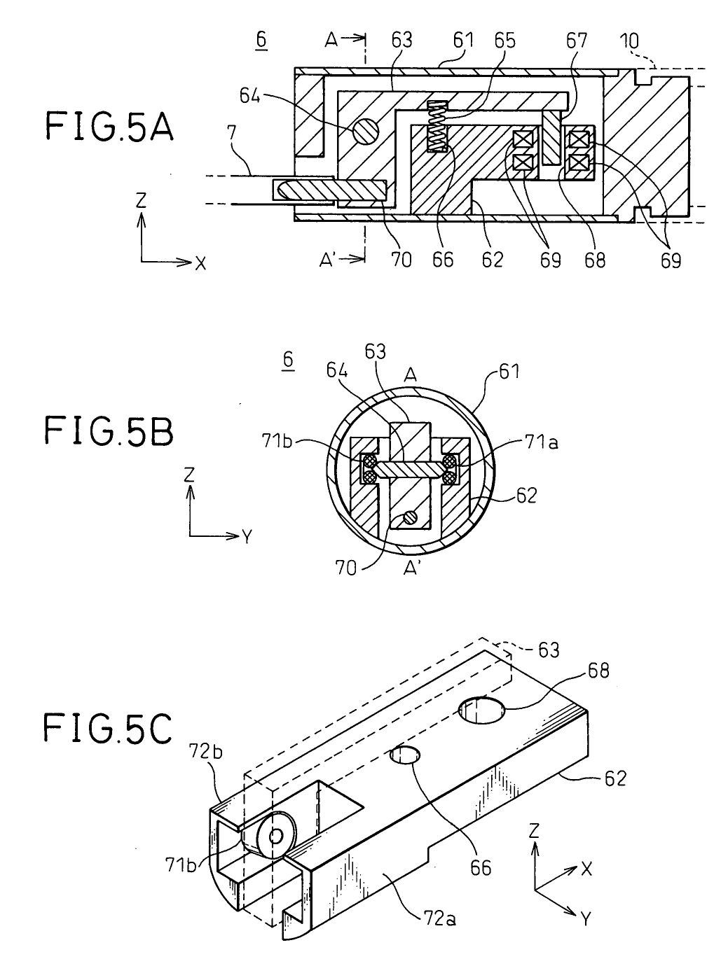

FIG. 5A is a side cross-sectional view of the pickup 6 taken in the X-Z plane in FIG. 4, and FIG. 5B is a cross-sectional view taken along line A-A′ in FIG. 5A. The pickup 6 contains, inside its case 61, a fixed part 62 fixed to the case 61 and a balancing movable part 63 supported on the fixed part 62 in such a manner as to be rotatable on a pivot shaft 64 extending in the Y direction. FIG. 5C is a perspective view for explaining the shape of the fixed part 62 shown in FIG. 5A.

As shown in FIG. 5C, the fixed part 62 is provided with arms 72a and 72b for holding the pivot shaft 64 of the balancing movable part 63 from both sides thereof, and bearings 71a and 71b for supporting the pivot shaft 64 are mounted on the respective arms 72a and 72b.

On the other hand, the balancing movable part 63 is provided with a cantilever mounting pin 70 for fixing the cantilever 7 to the balancing movable part 63. The cantilever 7 is fixed to the balancing movable part 63 by inserting the cantilever mounting pin 70 fixed to the balancing movable part 63 into a mounting hole formed in a mounting end of the cantilever 7.

The balancing movable part 63 is further provided with an urging means 65, such as a spring, by which the balancing movable part 63 with the cantilever 7 fixed thereto is urged in its turning direction so that the stylus 11 provided at the end of the cantilever 7 opposite from the mounting end thereof follows the surface of the workpiece in a contacting relationship therewith. In the example of FIG. 5A, the urging means 65 is a compression spring 65 fitted into a spring bearing recess 66 formed in the fixed part 62, and the balancing movable part 63 and the cantilever 7 fixed to it are urged by the compression spring 65 in the direction in which the stylus 11 is pointed (i.e., in the projecting direction thereof).

Therefore, when the pickup 6 is driven by the first and second movable units 4 and 8, the stylus 11 is allowed to move along the surface of the workpiece in such a manner as to follow the irregularities on the surface. Then, the displacement of the stylus 11 caused by the irregularities on the workpiece surface is transmitted to the balancing movable part 63 via the cantilever 7, causing the balancing movable part 63 to turn on the pivot shaft 64.

Further, as the stylus 11 moving along the workpiece surface is displaced by the irregularities on the workpiece surface, the amount of displacement is converted into an electrical signal by a differential inductance sensor provided in the pickup 6. The differential inductance sensor comprises a magnetic core 67 attached to the balancing movable part 63, a core insertion opening 68 formed in the fixed part 62 so as to accommodate the magnetic core 67, and two coils 69 provided around the core insertion opening 68 so as to encircle the magnetic core 67. The differential inductance sensor detects the movement of the magnetic core 67 associated with the motion of the balancing movable part 63 as a change in the difference between the inductances of the two coils 69, and thus converts the amount of displacement of the balancing movable part 63 into an electrical signal.

Then, the stylus 11 is moved across the entire area of the measurement surface, and signals sequentially output from the coils 69 are converted by an A/D converter (not shown) into digital signals and collected by a data processing unit (not shown) such as a computer, thereby acquiring measurement data indicating the surface roughness of the workpiece.

Here, the shape of the balancing movable part 63 and the position of the pivot shaft 64 are determined so that the weight of the assembly consisting of the cantilever 7, the balancing movable part 63, and the magnetic core 67 is balanced about the pivot shaft 64 as a fulcrum; that is, they are determined so that even when the pickup 6 is rotated by the pickup rotating unit 9 about the longitudinal direction of the cantilever 7 thereby changing the angle that the direction of the pivot shaft 64 (i.e., the direction of the rotational axis about which the cantilever 7 and the balancing movable part 63 turn) makes with the vertical direction, the force being exerted by the urging means 65 to press the stylus 11 against the measurement surface (i.e., the measuring force) does not change.

More specifically, the hole opened through the balancing movable part 63 to accommodate the pivot shaft 64 is provided at the center of mass of the assembly consisting of the cantilever 7, the balancing movable part 63, and the magnetic core 67 in a plane perpendicular to the pivot shaft 64.

When the position of the pivot shaft 64 is determined as described above, if the angle that the direction of the pivot shaft 64 makes with the vertical direction changes because of the rotation of the pickup 6 thereby changing the orientation of the assembly consisting of the cantilever 7, the balancing movable part 63, and the magnetic core 67, moment due to the gravitational force does not occur in the assembly and, as a result, the measuring force being exerted by the urging means 65 can be maintained constant.

Here, each end of the pivot shaft 64 may be formed in a substantially cone shape and the bearings 71a and 71b formed so as to support the substantially cone shaped ends of the pivot shaft 64 by spherical surfaces so that the balancing movable part 63 turns smoothly even when the pickup 6 is moved in the Y direction by the second movable unit 8 and when a yawing force is exerted on the cantilever 7 by the resulting frictional force occurring in the Y direction between the moving stylus 11 and the workpiece surface.

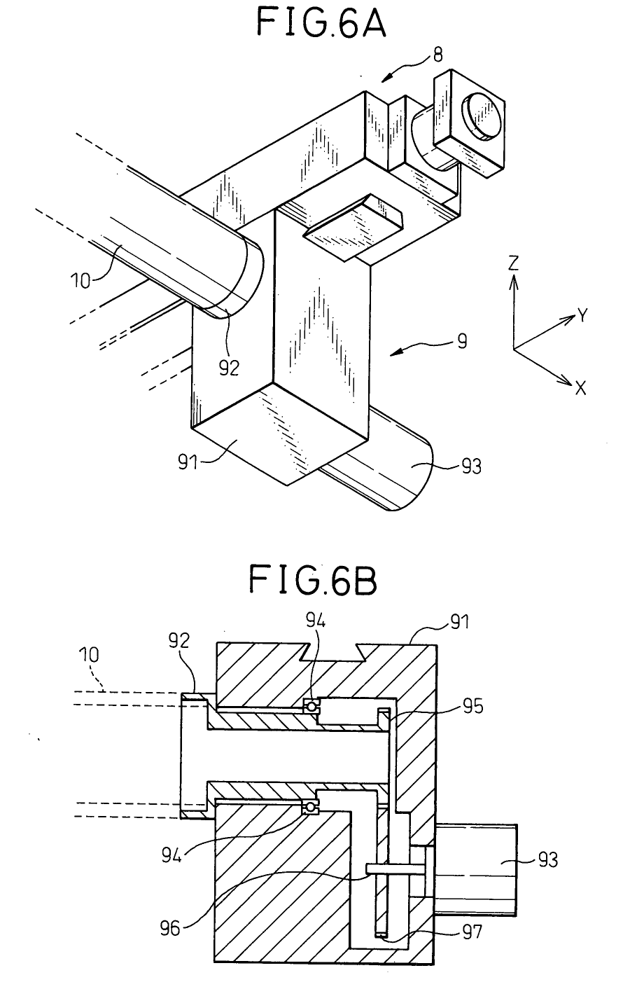

FIG. 6A is a perspective view of the pickup rotating unit 9, and FIG. 6B is a cross-sectional view of the pickup rotating unit 9 taken in the X-Z plane. The pickup rotating unit 9 comprises: a case 91 which is supported in such a manner as to be drivable in the Y direction by the second movable unit 8; a rotational attachment part 92 to which the arm 10 with the pickup 6 attached to one end thereof is fixed; a motor 93 which supplies a driving force for rotating the rotational attachment part 92 about the longitudinal direction of the arm 10 (i.e., the longitudinal direction of the cantilever 7); bearings 94 which support the rotational attachment part 92 in the case 91 in such a manner as to be rotatable about the longitudinal direction of the arm 10; and gears 95 and 97 which transmit the rotational motion of the rotating shaft 96 of the motor 93 to the rotational attachment part 92.

When the motor 93 rotates, the rotational force occurring on its rotating shaft 96 is transmitted via the gears 95 and 97 to rotate the rotational attachment part 92. As the rotational attachment part 92 is connected to the pickup 6 via the arm 10, the rotational motion of the rotational attachment part 92 causes the pickup 6 to rotate about the longitudinal direction of the cantilever 7.

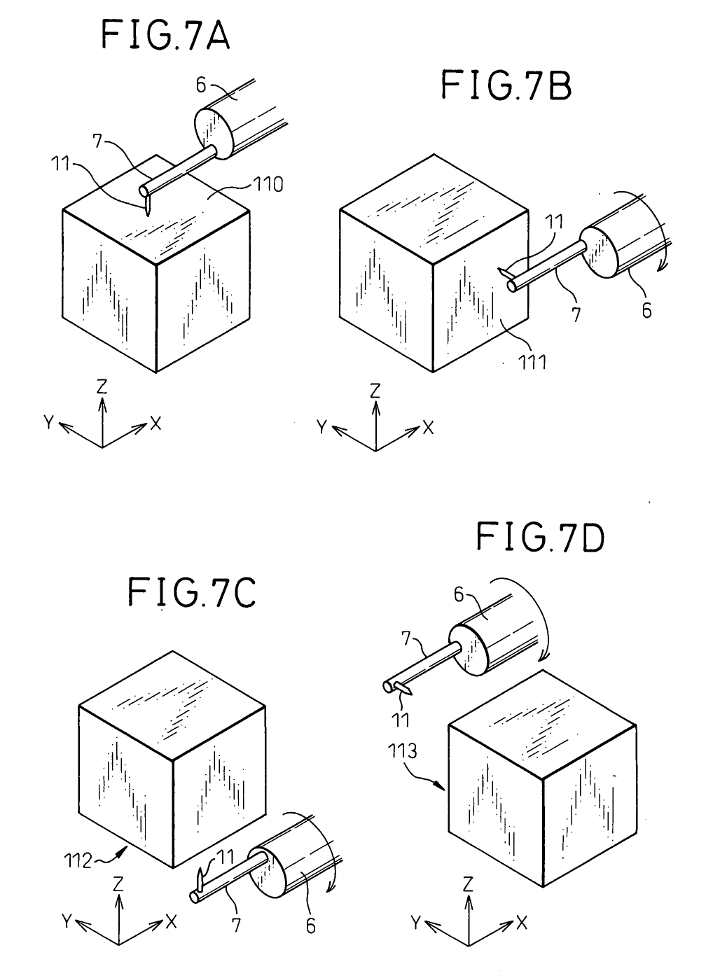

Thereupon, the balancing movable part 63 rotatably supported on the fixed part 62 of the pickup 6 and the cantilever 7 attached to the balancing movable part 63 are also caused to rotate about the longitudinal direction of the cantilever 7 and, as a result, the stylus orientation (the projecting direction) changes as shown in FIGS. 7A to 7D.

For example, when measuring a measurement surface 110 lying parallel to the X-Y plane and facing upward in the positive direction of the Z axis, as shown in FIG. 7A, the stylus 11 is held so as to point in the negative direction of the Z axis, as in the prior art measuring method.

Next, when measuring a measurement surface 111 lying parallel to the Z-X plane and facing in the negative direction of the Y axis, as shown in FIG. 7B, the pickup 6 is rotated 90 degrees in the direction of arrow in the figure about the longitudinal direction (X direction) of the cantilever 7, thus orienting the stylus 11 in the positive direction of the Y axis and allowing the stylus tip to contact the measurement surface 111; in this condition, the stylus 11 is moved along the measurement surface 111 to measure its surface roughness or surface contour.

On the other hand, when measuring a measurement surface 112 lying parallel to the X-Y plane and facing in the negative direction of the Z axis, as shown in FIG. 7C, the pickup 6 is further rotated 90 degrees in the direction of arrow in the figure, thus orienting the stylus 11 in the positive direction of the Z axis and allowing the stylus tip to contact the measurement surface 112; in this condition, the stylus 11 is moved along the measurement surface 112 to measure its surface roughness or surface contour.

When measuring a measurement surface 113 lying parallel to the X-Z plane and facing in the positive direction of the Y axis, as shown in FIG. 7D, the pickup 6 is further rotated 90 degrees in the direction of arrow in the figure, thus orienting the stylus 11 in the negative direction of the Y axis and allowing the stylus tip to contact the measurement surface 113; in this condition, the stylus 11 is moved along the measurement surface 113 to measure its surface roughness or surface contour.

In this way, by rotating the pickup 6 and changing the orientation of the stylus 11 according to the orientation of the measurement surface, the measurement surface that cannot be measured with the prior art measuring apparatus without changing the orientation of the workpiece can be measured without changing the orientation of the workpiece.

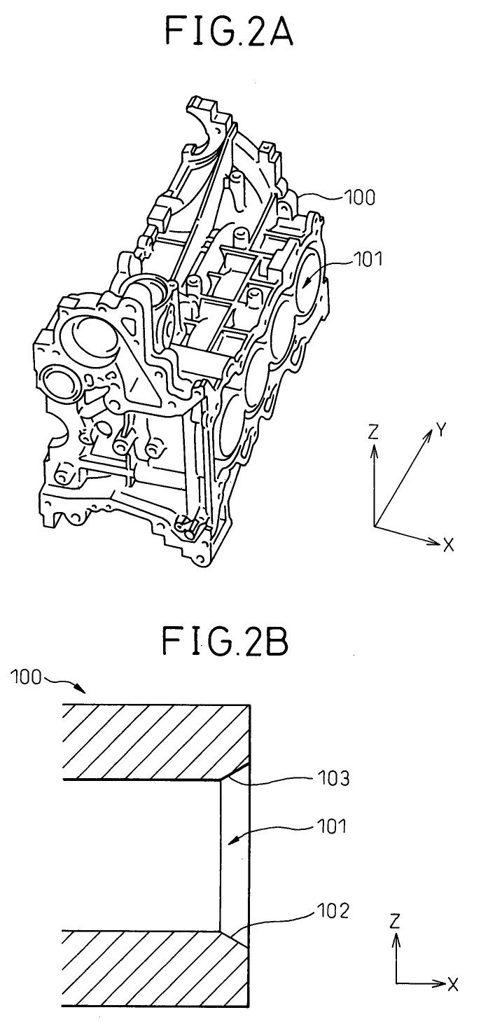

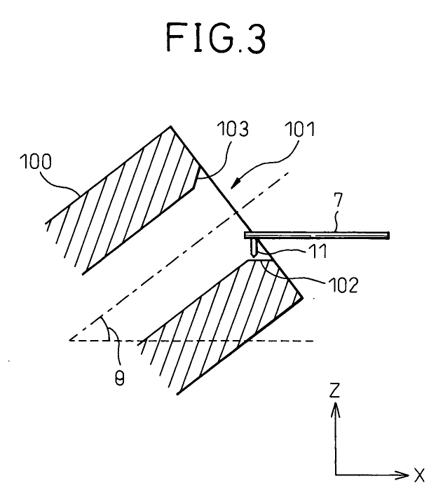

Furthermore, when measuring a rectangular workpiece such as the cylinder block 100 previously described with reference to FIGS. 2 and 3, the number of directions about which the workpiece 100 needs to be rotated for measurement can be reduced, reducing the labor required to set the rotational axis of the rotating tool for rotating the workpiece 100.

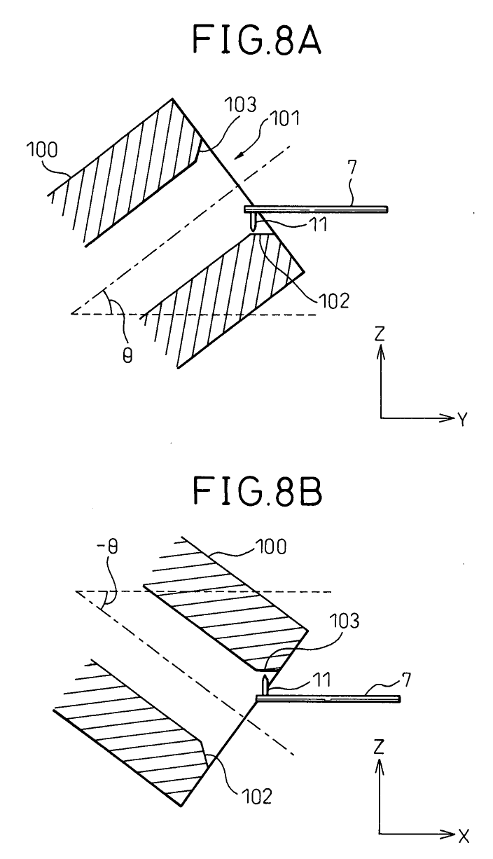

The surface-roughness/contour measurement will be described with reference to FIGS. 8A and 8B by taking as an example the case of measuring the tapered portions (102 and 103) formed on the open end of the cylinder 101 shown in FIG. 2B.

Of these tapered portions (102 and 103), when measuring the surface roughness or contour of the portion 102 whose surface faces upward (in the positive direction of the Z axis), the entire workpiece 100 is tilted, for example, as previously shown in FIG. 3, by the taper angle θ about the Y axis in the figure, thereby leveling the surface of the tapered portion 102, and the stylus 11 is brought into contact with that surface (FIG. 8A).

On the other hand, when measuring the surface roughness or contour of the tapered portion 103 whose surface faces downward (in the negative direction of the Z axis), the entire workpiece 100 is tilted, as shown in FIG. 8B, by the taper angle (−θ) about the Y axis in the figure, thereby leveling the surface of the tapered portion 103, while at the same time, the cantilever 7 is rotated 180 degrees to orient the stylus 11 in the positive direction of the Z axis so that the stylus tip can be brought into contact with the tapered portion 103.

In this way, in the surface-roughness/contour measurement, which, in the prior art, had to be performed by rotating the workpiece 100 about a plurality of directions, the number of directions about which the workpiece 100 needs to be rotated can be reduced by one by changing (rotating) the orientation of the stylus 11.

As described above, according to the present invention, by providing the balancing member for balancing the weight of the cantilever, it becomes possible to eliminate the effect of gravitational force acting on the cantilever when orientation of the stylus is changed by rotating the cantilever. As a result, the orientation of the stylus can be changed in various ways to match variously oriented measurement surfaces, and variously oriented measurement surfaces can thus be measured without changing the mounting orientation of the workpiece.

The present invention is generally applicable to surface-roughness/contour measuring apparatus, and in particular, the invention is applicable to a surface-roughness/contour measuring apparatus that measures the surface roughness or contour of a measurement object (workpiece) by moving a stylus along the surface of the measurement object and by detecting the amount of displacement of the stylus.

While one preferred mode of the present invention has been described in detail above, it will be understood, by those skilled in the art, that various modifications and changes can be made by anyone skilled in the art, and that all of such modifications and changes that come within the range of the true spirit and purpose of the present invention fall within the scope of the present invention as defined by the appended claims.

### DESCRIPTION OF REFERENCE NUMERALS

1—SURFACE-ROUGHNESS/CONTOUR MEASURING APPARATUS
2—TABLE
3—COLUMN
4—FIRST MOVABLE UNIT
6—PICKUP
7—CANTILEVER
8—SECOND MOVABLE UNIT
9—PICKUP ROTATING UNIT
10—ARM
11—STYLUS

What is claimed is:

1. A surface-roughness/contour measuring apparatus comprising: a cantilever; a stylus provided at one end of said cantilever; a rotatable support part which supports said cantilever in such a manner as to be rotatable on a rotational axis extending in a direction perpendicular to a longitudinal direction of said cantilever; an urging member which urges said cantilever in a direction in which said stylus is oriented; and a detector which detects a rotational displacement occurring in said cantilever when said stylus is moved along a workpiece surface in contacting relationship therewith, wherein said surface-roughness/contour measuring apparatus is characterized by comprising:
a stylus orientation changing part which changes the orientation of said stylus by rotating said rotatable support part about the longitudinal direction of said cantilever; and
a balancing member which balances the weight of said cantilever about said rotational axis.

2. A surface-roughness/contour measuring apparatus as claimed in claim 1, wherein said stylus orientation changing part orients said stylus in a direction that causes a tip of said stylus to contact a measurement surface, thereby measuring a surface shape of said measurement surface.
